(19) United States
(12) Patent Application Publication
(10) Pub. No.: US 2015/0226914 A1
(43) Pub. Date: Aug. 13, 2015

(54) OPTICAL FIBER

(71) Applicant: SUMITOMO ELECTRIC INDUSTRIES, LTD., Osaka-shi, Osaka (JP)

(72) Inventors: Masaaki Hirano, Yokohama-shi (JP); Tetsuya Haruna, Yokohama-shi (JP); Yoshiaki Tamura, Yokohama-shi (JP); Yoshinori Yamamoto, Yokohama-shi (JP)

(73) Assignee: SUMITOMO ELECTRIC INDUSTRIES, LTD., Osaka-shi, Osaka (JP)

(21) Appl. No.: 14/425,378

(22) PCT Filed: Sep. 2, 2013
(86) PCT No.: PCT/JP2013/073547

§ 371 Date: Mar. 3, 2015

(30) Foreign Application Priority Data
Sep. 4, 2012 (JP) 2012-194260

(51) Int. Cl. G02B 6/02; G02B 6/036

(52) U.S. Cl. CPC G02B 6/02014; G02B 6/02266; G02B 6/03611; G02B 6/03627

(57) ABSTRACT

Provided is an optical fiber that is suitable for high-density packing and long-haul transmission. An optical fiber according to the present invention includes a core and a cladding. At a wavelength of 1550 nm, an effective area Aeff is 100 μm² or less and a chromatic dispersion Disp is 19.0 ps/nm/km or more and 22 ps/nm/km or less, and, when an effective length is denoted by Leff and an attenuation is denoted by cc, a figure of merit FOM represented by an expression “FOM=5 log{|Disp|·Leff}−10 log {Leff/Aeff}−100α” is 3.2 dB or more.

### TECHNICAL FIELD

The present invention relates to an optical fiber.

### BACKGROUND ART

Regarding a communication system employing digital coherent receiver technology, it is important to improve the optical signal-to-noise ratio (OSNR) of an optical communication system. By improving the OSNR, the performance of an optical communication system can be improved, for example, in the following aspects: the capacity of a transmission system can be increased; the transmission distance of a transmission system can be increased; and the span length between repeaters can be increased. In order to improve OSNR, it is important to reduce the non-linearity of an optical fiber and to reduce the loss in a transmission line. The non-linearity of an optical fiber can be reduced by increasing the effective area Aeff and by increasing the absolute value of chromatic dispersion. WO00/062106 and JP2005-20440A each describe a non-dispersion-shifted optical fiber whose chromatic dispersion is large in absolute value and whose effective area Aeff is large.

In existing transmission lines and transmission apparatuses, the following optical fibers are used: standard single-mode optical fibers (SSMF) that have an effective area Aeff of about 80 μm² in a 1.55 μm wavelength band and that are compliant with ITU-T G.652 recommendation; and dispersion-shifted optical fibers (DSF) and non-zero dispersion-shifted optical fibers (NZ-DSF) that have an effective area Aeff in the range of 50 to 80 μm² and that are respectively compliant with ITU-T G.653 and 6.655 recommendations. JP2011-197667A describes that a splice loss may become high when one of these optical fibers is spliced to a non-dispersion-shifted optical fiber having a large effective area Aeff, and, as a result, the OSNR may decrease.

In addition, when a terrestrial long-distance communication cable or a submarine repeaterless communication cable, in which optical fibers are densely packed, is made from non-dispersion-shifted optical fibers having a large effective area Aeff, the attenuation of the optical fibers may be increased because of macrobend loss or microbend loss, and, as a result, the OSNR of the transmission system may decrease.

As described in WO00/036443, there is a known technology for compensating for the chromatic dispersion of a negative dispersion fiber by using a positive dispersion optical fiber that has a comparatively small effective area Aeff and a comparatively large chromatic dispersion. The positive dispersion optical fiber, with which a bend-induced loss can be reduced, can be also used as a dispersion compensation module. However, the fiber is not suitable for practical long-haul transmission, because it has an attenuation of 0.17 dB/km or more.

The specification of US2010/0195966 describes a fiber whose attenuation is reduced by doping a core with an alkali metal. However, optical fibers (Examples 8, 13, 14, and 15) described in this specification, which has a small effective area Aeff, is not suitable for practical long-haul transmission, because the attenuation of each of the optical fibers is 0.17 dB/km or more. Thus, an optical fiber that is suitable for high-density packing in an optical cable and that is suitable for long-haul transmission using a digital coherent system has not been examined to date.

### SUMMARY OF INVENTION

### Technical Problem

An object of the present invention is to provide an optical fiber that is applicable to high-density implementation and long-haul transmission system.

### Solution to Problem

An optical fiber according to the present invention includes a core and a cladding. At a wavelength of 1550 nm, an effective area Aeff is 100 μm² or less and a chromatic dispersion Disp is 19.0 ps/nm/km or more and 22 ps/nm/km or less, and, a figure of merit FOM represented by an expression

FOM=5 log{|Disp|·Leff}−10 log{Leff/Aeff}−100α

is 3.2 dB or more, where an effective length of the optical fiber is denoted by Leff [km] and an attenuation of the optical fiber is denoted by a [dB/km].

In the optical fiber according to the present invention, the attenuation α at a wavelength of 1550 nm may be 0.164 dB/km or less. The effective area Aeff at a wavelength of 1550 nm may be 76 μm² or more, or may be 62 μm² or more. A fiber cut-off wavelength measured on a 2 m length of the optical fiber may be 1.30 μm or more and 1.60 μm or less. A dispersion slope S at a wavelength of 1550 nm may be 0.05 ps/nm²/km or more and 0.07 ps/nm²/km or less. A splice loss when spliced to a single-mode optical fiber having an effective area of 80 μm² may be 0.05 dB/facet or less at a wavelength of 1550 nm.

In the optical fiber according to the present invention, a relative refractive index difference of the core with respect to a refractive index of pure silica glass may be 0.1% or more and 0.1% or less. The core may be made of a silica-based glass that is doped with chlorine with an average concentration of 1000 atomic ppm or more. The core may be doped with an alkali metal with an average concentration of 0.01 atomic ppm or more and 50 atomic ppm or less. A concentration of a main-group metal and a transition metal in the core may be 1 ppm or less.

In the optical fiber according to the present invention, a diameter 2r_{c} of the core may be 9.0 μm or more and 11.6 μn or less, and a relative refractive index difference Δ_{c}=(N_{c}−N_{d2})/N_{d2} of a maximum refractive index N_{c} of the core with respect to a minimum refractive index N_{d2} of the cladding in a distance range of r_{c} or more and 4.5r_{c} or less from the center axis of the optical fiber may be 0.34% or more and 0.62% or less. The core may include a first core and a second core, the first core having a minimum refractive index Nᵢ, a maximum refractive index Nᵢ₂, and an outer radius rᵢ, the second core having a maximum refractive index N_{c} and an outer radius r_{c}, where N_{c}≧Nᵢ₂, r_{c}≧rᵢ, and 2r_{c} is 9.0 μm or more and 11.0 μm or less, and a relative refractive index difference Δ_{c}=(N_{c}−N_{d2})/N_{d2} of the maximum refractive index N_{c} of the second core with respect to the minimum refractive index N_{d2} of the cladding in the distance range of r_{c} or more and 4.5r_{c} or less from the axis may be 0.40% or more and 0.62% or less. A relative refractive index difference Δᵢ=(N_{c}−Nᵢ)/Nᵢ may be 0.05% or more and 0.25% or less.

In the optical fiber according to the present invention, the cladding may include a first cladding and a second cladding, the first cladding having an outer radius r_{d}, a maximum refractive index N_{d1}, and a minimum refractive index N_{d2}, the second cladding having an outer radius rₒ, a maximum refractive index Nₒ, and a minimum refractive index Nₒ₂, where N_{c}>Nₒ₂>N_{d1} and r_{c}<r_{d}<rₒ; a relative refractive index difference Δ_{d}=(Nₒ−N_{d2})/N_{d2} of the maximum refractive index Nₒ of the second cladding with respect to the minimum refractive index N_{d2} of the first cladding may be 0.05% or more and 0.25% or less; and a ratio Ra=r_{d}/r_{c} of the outer radius r_{d} of the first cladding to the outer radius r_{c} of the core may be 3.0 or more and 4.5 or less.

In the optical fiber according to the present invention, the core may have a minimum refractive index Nᵢ at a distance rᵢ from the center axis of the optical fiber, the core may have a maximum refractive index N_{c} at a distance rₓ from the axis, and, when an outer diameter of the core is denoted by r_{c}, r₁<rₓ≦r_{c}, R_{c}=r_{c}/rₓ may be 1 or more and 5.0 or less, and 9 μm≦2r_{c}≦11 μm; a relative refractive index difference Δᵢ=(N_{c}−Nᵢ)/Nᵢ of the maximum refractive index N_{c} of the core with respect to the minimum refractive index Nᵢ of the core may be 0.05% or more and 0.25% or less; and a relative refractive index difference Δ_{c}=(N_{c}−N_{d2})/Nₒ of the maximum refractive index N_{c} of the core with respect to the minimum refractive index N_{d2} in a distance range of r_{c} or more and 4.5r_{c} or less from the axis may be 0.40% or more and 0.62% or less.

The optical fiber according to the present invention is an optical fiber that includes a core and a cladding and that has, at a wavelength of 1550 nm, an effective area Aeff that is 62 μm² or more and 100 μm² or less, a chromatic dispersion Disp that is 22 ps/nm/km or less, an attenuation α that is 0.164 dB/km or less, and a dispersion slope S that is 0.05 ps/nm²/km or more and 0.07 ps/nm²/km or less. At a wavelength of 1550 nm, the chromatic dispersion Disp may be 15 ps/nm/km or more.

### Advantageous Effects of Invention

With the present invention, an optical fiber that is applicable to high-density implementation and long-haul transmission system can be provided.

### BRIEF DESCRIPTION OF DRAWINGS

FIG. 1 is a graph representing the relationship between effective area Aeff and microbend-induced loss increase at a wavelength of 1550 nm by using chromatic dispersion Disp as a parameter.

FIG. 2 is a graph representing the relationship between splice loss of an optical fiber and effective area Aeff of the optical fiber at a wavelength of 1550 nm when spliced to a dissimilar optical fiber, which is a standard single-mode optical fiber having an effective area of 80 μm².

FIG. 3 is a graph representing the relationship between attenuation α and effective area Aeff at a wavelength of 1550 nm by using figure of merit FOM as a parameter.

Section (a) and section (b) of FIG. 4 are conceptual diagrams illustrating preferable examples of the refractive index profile of an optical fiber according to the present invention.

FIG. 5 is a conceptual diagram illustrating a design example of an optical fiber having a single-peak-core refractive index profile.

FIG. 6 is a graph representing contour lines of parameters of an optical fiber, which has a single-peak-core refractive index profile, the graph having relative refractive index difference Δ_{c} along the horizontal axis and diameter 2r_{c} along the vertical axis.

FIG. 7 is a diagram illustrating a refractive index profile of an optical fiber.

FIG. 8 is a conceptual diagram illustrating a design example of an optical fiber having a ring-core refractive index profile.

FIG. 9 is a graph representing contour lines of parameters of an optical fiber, which has a ring-core refractive index profile, the graph having a relative refractive index difference Δ_{c} along the horizontal axis and a diameter 2r_{c} along the vertical axis.

FIG. 10 is a graph representing the relationship between chromatic dispersion and FOM, which is represented by expression (1a), in a case where attenuation α is 0.15 dB/km by using Aeff as a parameter.

### DESCRIPTION OF EMBODIMENTS

Hereinafter, embodiments of the present invention will be described in detail with reference to the drawings. The same elements in the drawings will be denoted by the identical numerals and redundant description of such elements will be omitted.

In the present specification, at a wavelength of 1550 nm, the chromatic dispersion of an optical fiber is denoted by Disp [ps/nm/km], the effective area is denoted by Aeff [μm²], the attenuation is denoted by a [dB/km], the span length is denoted by L, [km], and the effective length is denoted by Leff [km]. The figure of merit FOM of the optical fiber is represented by expressions (1a), (1b), and (1c).

FOM=5 log{|Disp|·Leff}−10 log{Leff/Aeff}−α×100 km (1a)

Leff=(1−exp(−α′L))/α′ (1b)

α′=α/4.343 (1c)

According to A. Carena, et al., ECOC2011, Th.12.LeCervin.5, the figure of merit FOM of an optical fiber is represented by expression (2a). Expression (1a) can be obtained by applying expressions (2b) and (2c) to expression (2a) and assuming that the span length L is 100 km. Here, C denotes the velocity of light in vacuum, and λ denotes the wavelength (here, 1550 nm). The value of n₂, which denotes the nonlinear refractive index of the optical fiber, is set to 2.18×10⁻²⁰ m²/W for a pure silica core optical fiber. Note that the difference between expressions (1a) and (2a) is a constant.

FOM=5 log {|β2|·Leff}−10 log{γ·Leff}−α×L (2a)

β2=−2πC×Disp/λ² (2b)

γ=(n₂/Aeff)×(2π/λ) (2c)

According to R. Cigliutti, et al., JLT V.29, No.15, pp.2310-2318, 2011, for a commercial pure silica core optical fiber, α=0.168 dB/km, Aeff=110 μm², and Disp=20.6 ps/nm/km. Therefore, the figure of merit FOM is 3.2 dB. Accordingly, high-speed transmission can be performed by using an optical fiber having a figure of merit FOM that is equal to or higher than that of this pure silica core optical fiber. Preferably, the figure of merit FOM is higher and more preferably, for example, 3.7 dB or higher.

As can be seen from expression (1a), the figure of merit FOM increases as the absolute value of the chromatic dispersion Disp increases, as the effective area Aeff increases, and as the attenuation α decreases; and a performance in an optical transmission system can be improved. FOM become equal to 3.2 dB when, for example, Aeff=100 μm², Disp=21.0 ps/nm/km, and α=0.163 dB/km. FOM become equal to 3.2 dB when Aeff=90 μm², Disp=20.0 ps/nm/km, and α=0.157 dB/km. FOM become equal to 3.2 dB when Aeff=80 μm², Disp=19.5 ps/nm/km, and α=0.151 dB/km.

However, if the effective area Aeff becomes excessive large, the microbend-induced loss will increase, and a large attenuation may occur when the optical fiber is installed into a cable. Moreover, in general, a splice loss will become higher when spliced to a single-mode optical fiber or a NZ-DSF that has been generally laid. Therefore, it is not preferable that the effective area Aeff be too large.

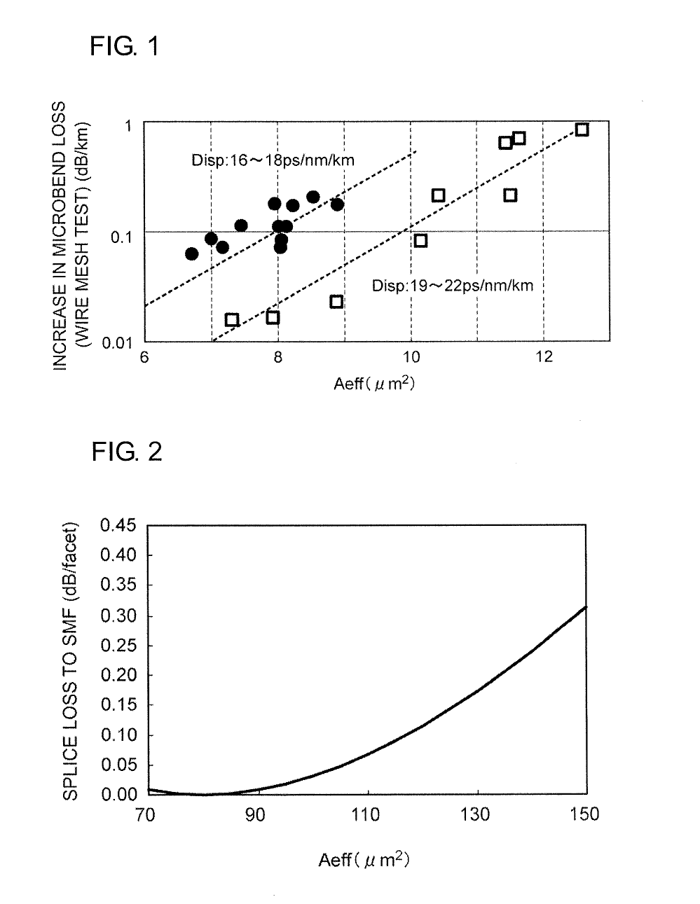

FIG. 1 is a graph representing the relationship between effective area Aeff and microbend-induced loss increase at a wavelength of 1550 nm by using chromatic dispersion Disp as a parameter. The horizontal axis represents the effective area Aeff, and the vertical axis represents the microbend-induced loss increase. Two broken lines respectively represent a trend line in a case where the chromatic dispersion Disp is in the range of 19 to 22 ps/nm/km and a trend line in a case where the chromatic dispersion Disp is in the range of 16 to 18 ps/nm/km. The microbend-induced loss is represented by an increase in the loss when the optical fiber is wound, with a tension of 80 g, around a bobbin that has a diameter of 400 mm and that is covered with a mesh of wires each of which has a diameter of 50 μm and which are arranged with a pitch of 100 μm.

For the same effective area Aeff, the microbend-induced loss in the case where the chromatic dispersion Disp is in the range of 19 to 22 ps/nm/km, which is large, is smaller than that in the case where the chromatic dispersion Disp is in the range of 16 to 18 ps/nm/km. A single-mode optical fiber that is generally used in a terrestrial cable has a chromatic dispersion Disp of 17 ps/nm/km and an effective area Aeff of about 80 μm². It is preferable that the chromatic dispersion Disp be in the range of 19 to 22 ps/nm/km and the effective area Aeff be 100 μm² or less in order to have a microbend-induced loss characteristic equivalent to this optical fiber. The attenuation of a pure silica core optical fiber, which has a core made of a substantially pure silica glass, decreases as the chromatic dispersion increases, because the power of transmitted lightwave is concentrated more on the pure silica core as the chromatic dispersion increases.

It is preferable that the macrobend loss of an optical fiber be smaller. For example, when the optical fiber is wound with a diameter of 20 mm, the macrobend loss at a wavelength of 1550 nm is preferably 20 dB/m or less, more preferably 10 dB/m or less, and still more preferably 3 dB/m or less. When the optical fiber is wound with a diameter of 30 mm, the bend-induced loss becomes smaller, and preferably, the bend-induced loss at a wavelength of 1550 nm is 2 dB/m or less, and more preferably 1 dB/m or less. When the optical fiber is wound with a diameter of 60 mm, preferably, the bend-induced loss in a wavelength range lower than 1625 nm is 0.01 dB/m or less.

In general, a cladding glass portion of a transmission optical fiber is coated with two-layered resin coating. In order to suppress microbend-induced loss increase of an optical fiber, it is preferable that a primary resin coating have a low Young's modulus and a secondary resin coating have a high Young's modulus. To be specific, preferably, the primary resin coating has a Young's modulus in the range of 0.2 to 2 MPa, and more preferably in the range of 0.2 to 1 MPa; and the secondary resin coating has a Young's modulus in the range of 500 to 2000 MPa, and more preferably in the range of 1000 to 2000 MPa.

In order to reduce the microbend-induced loss of an optical fiber, a method of increasing the diameter of a cladding glass or the outer diameter of a resin coating may be preferably used. However, enlargement the difference from a generally used optical fiber (the glass diameter: 125 μm, the cover outer diameter: 245 μm) is not practical. The outer diameter of the cladding glass may be in the range of 123 to 127 μm, and the outer diameter of the resin coating may be in the range of 230 to 260 μm.

FIG. 2 is a graph representing the relationship between splice loss of an optical fiber and effective area Aeff of the optical fiber at a wavelength of 1550 nm when spliced to a dissimilar optical fiber, which is a standard single-mode optical fiber having an effective area of 80 μm². As the effective area Aeff increases, the dissimilar splice loss when spliced to an optical fiber of a different type increases, and, as a result, the performance of the system decreases. It is preferable that the effective area Aeff be about 100 μm² or less, because, in this case, the splice loss when spliced to a standard single-mode optical fiber, having an effective area of 80 μm², is about 0.05 dB/facet or less.

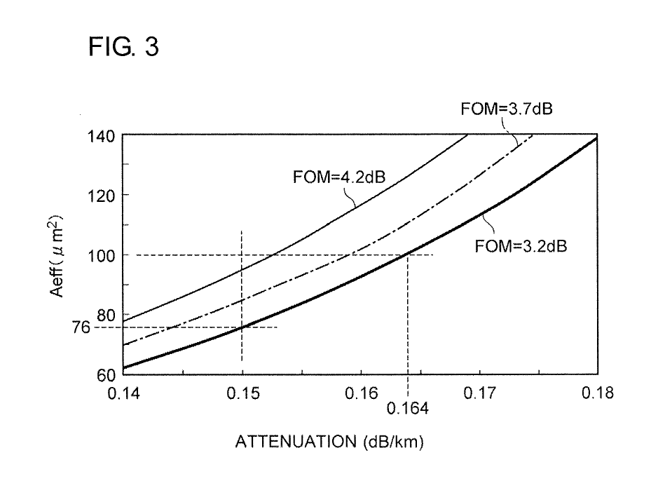

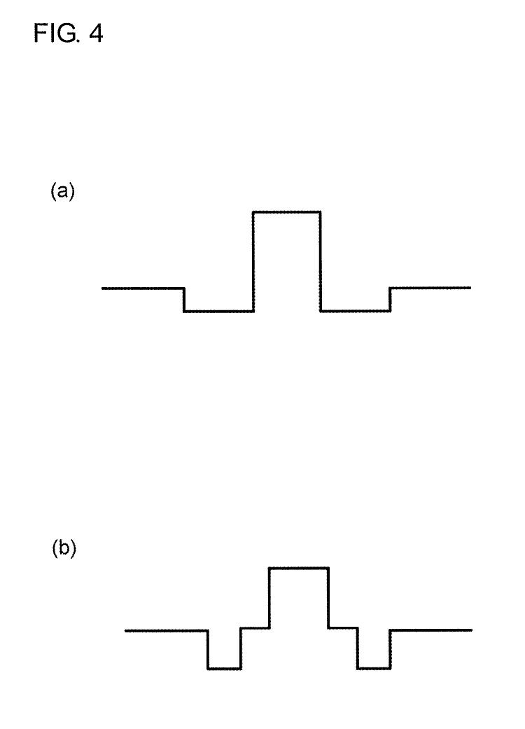

FIG. 3 is a graph representing the relationship between attenuation α and effective area Aeff at a wavelength of 1550 nm by using the figure of merit FOM as a parameter. The horizontal axis represents the attenuation α, and the vertical axis represents the effective area Aeff. The curves respectively represent contour lines for the cases where the figure of merit FOM has values of 3.2, 3.7, and 4.2 dB. Here, it is assumed that the chromatic dispersion Disp is 21 ps/nm/km.

When the effective area Aeff is 100 μm², it is preferable that the attenuation α be 0.164 dB/km or less so that the figure of merit FOM can be 3.2 dB or more, it is preferable that the attenuation α be 0.159 dB/km or less so that the figure of merit FOM can be 3.7 dB or more, and it is preferable that the attenuation α be 0.152 dB/km or less so that the figure of merit FOM can be 4.2 dB or more. At present, an attenuation α of 0.15 dB/km is realized. In this case, if the effective area Aeff is 76 μm² or more, the figure of merit FOM is 3.2 dB or more. Accordingly, it is preferable that the effective area Aeff be 76 μm² or more. However, it is expected that the attenuation α will decrease as the technology will develop in the future. For example, assuming that the attenuation α will be reduced to about 0.14 dB/km, it is preferable that the effective area Aeff be 62 μm² or more.

FIG. 10 is a graph representing the relationship between chromatic dispersion and FOM, which is represented by expression (1a), in a case where attenuation α is 0.15 dB/km by using Aeff as a parameter. The solid line represents the relationship in a case where Aeff is 90 μm², and the broken line represents the relationship a case where Aeff is 80 μm². It is preferable that the chromatic dispersion be large, because the FOM increases as the chromatic dispersion comes to be higher. It is preferable that the chromatic dispersion be 15 ps/nm/km or more when Aeff=90 μm² and the chromatic dispersion be 19 ps/nm/km or more when Aeff−80 μm² because, in these cases, the FOM becomes 3.2 dB.

In order to realize a low-loss optical fiber having an attenuation α of 0.164 dB/km or less, it is preferable that the optical fiber have a core made of a substantially pure silica glass and that the relative refractive index difference (N_{c}−N_{SiO2})/N_{SiO2} of the maximum refractive index N_{c} of the core with respect to the refractive index N_{SiO2} of the pure silica glass be −0.1% or more and 0.1% or less. The core may be doped with chlorine with an average concentration of 1000 atomic ppm or more or may be doped with fluorine with an average concentration of 100 atomic ppm or more. The core may be doped with an alkali metal with an average concentration of 0.01 atomic ppm or more and 50 atomic ppm or less. The alkali metal may be potassium, sodium, rubidium, or the like. In such a case, the viscosity of the core can be reduced, and therefore the attenuation can be reduced to 0.16 dB/km or less. It is preferable that the concentration of main-group metals (Ge, Al, and the like) and transition metals (Ni, Fe, Mn, and the like) in the core be 1 ppm or less, because, in this case, the scattering loss and the absorption loss due to the transition metals and the main-group metals can be suppressed.

Section (a) and section (b) of FIG. 4 are conceptual diagrams illustrating preferable examples of the refractive index profile of an optical fiber according to the present invention. An optical fiber having a large effective area Aeff will have a problem of a large bend-induced loss. However, the bend-induced loss can be reduced by forming around the core a low refractive index region, which has a refractive index lower than the outside of the low refractive index region. The refractive index profiles illustrated in section (a) and section (b) are both preferable for an optical fiber for long-haul transmission. The profile illustrated in section (a), which is known as a W cladding type profile, is more preferable, because it is suitable for mass-production.

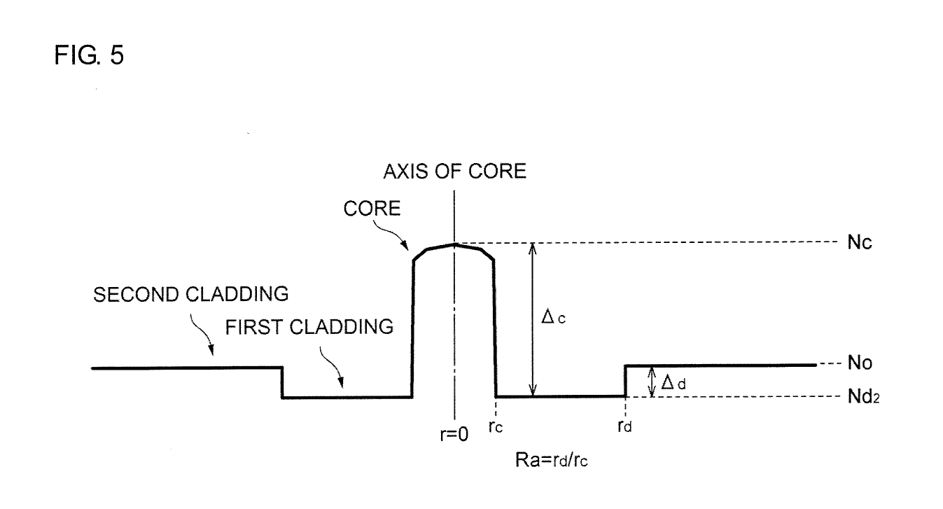

FIG. 5 is a conceptual diagram illustrating a design example of an optical fiber having a single-peak-core refractive index profile. The optical fiber includes a core that has a single-peak refractive index profile, a first cladding that surrounds the core, and a second cladding that surrounds the first cladding. Let r_{c} denote the outer radius of the core and N_{c} denote the maximum refractive index of the core. Let r_{d} denote the outer radius of the first cladding, N_{d1} denote the maximum refractive index of the first cladding, and N_{d2} denote the minimum refractive index of the first cladding. Let rₒ denote the outer radius of the second cladding, Nₒ denote the maximum refractive index of the second cladding, and Nₒ₂ denote the minimum refractive index of the second cladding. These parameters satisfy the relationships N_{c}>Nₒ₂>N_{d1} and r_{c}<r_{d}<rₒ. Let Δ_{c}=(N_{c}−N_{d2})/N_{d2} denote the relative refractive index difference of the maximum refractive index N_{c} of the core with respect to the minimum refractive index N_{d2} of the first cladding, and let Δ_{d}=(Nₒ−N_{d2})/N_{d2} denote the relative refractive index difference of the maximum refractive index Nₒ of the second cladding with respect to the minimum refractive index N_{d2} of the first cladding. Let Ra=r_{d}/r_{c} denote the ratio of the outer radius of the first cladding r_{d} to the outer radius of the core r_{c}.

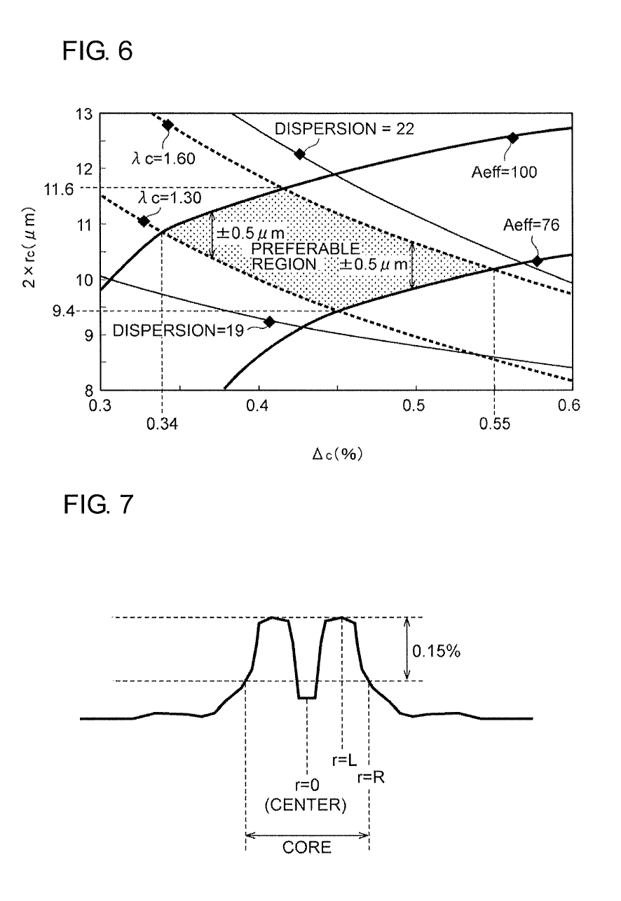

FIG. 6 is a graph representing contour lines of parameters of an optical fiber, which has a single-peak-core refractive index profile, the graph having relative refractive index difference Δ_{c} along the horizontal axis and diameter 2r_{c} along the vertical axis. The curves in FIG. 6 represent the following, where Δ_{d}=0.15% and Ra−3.8: a contour line along which the fiber cut-off wavelength λ_{c} on a 2 m length of an optical fiber is 1.60 μm (corresponding to a cable cut-off wavelength of 1.52 μm on a 22 m length of the optical fiber); a contour line along which the fiber cut-off wavelength λ_{c}, on a 2 m length of an optical fiber is 1.30 μm (corresponding to a cable cut-off wavelength of 1.22 μm on a 22 m length of the optical fiber); a contour line along which the effective area Aeff at a wavelength of 1550 nm is 100 μm²; a contour line along which the effective area Aeff at a wavelength of 1550 nm is 76 μm²; a contour line along which the chromatic dispersion Disp at a wavelength of 1550 nm is 19 ps/nm/km; and a contour line along which the chromatic dispersion Disp at a wavelength of 1550 nm is 22 ps/nm/km.

It is preferable that the relative refractive index difference Δ_{c} and the diameter 2r_{c} be in a region (hatched region) in which the fiber cut-off wavelength λ_{c} on a 2 m length of an optical fiber is 1.30 μm or more and 1.60 μm or less, the effective area Aeff is 76 μm² or more and 100 μm² or less, and the chromatic dispersion Disp is 19 ps/nm/km or more and 22 ps/nm/km or less. For a single-peak-core optical fiber, it is preferable that Δ_{c} be 0.34% or more and 0.55% or less and the core diameter be in the range of 9.4 to 11.6 μm. It is more preferable that Δ_{c} be in the range of 0.38 to 0.49% so that a range of the core diameter in which the transmission characteristic is preferable can be broad as ±0.5 μm or more.

It is preferable that the ratio Ra=r_{d}/r_{c} of the outer radius of the first cladding r_{d} to the outer radius of the core r_{c} be 3.0 or more and 4.5 or less. It is preferable that the relative refractive index difference Δ_{d} of the maximum refractive index Nₒ of the second cladding with respect to the minimum refractive index N_{d2} of the first cladding be in the range of 0.08 to 0.20%. In this case, the bending characteristics can be improved.

The radius r_{d} of the core is defined as follows. Referring to FIG. 7, let N(r) denote the refractive index at a distance r in the radial direction from the axis of the optical fiber. It is assumed that the refractive index N(L) at a distance L in the radial direction is the maximum value N_{max.} It is assumed that (Nₘₐₓ−N(R))/Nₘₐₓ is 0.15%, where R denotes a distance in the radial direction such that L<R. The radius r_{d} of the core is defined as the radius R.

The outer radius r_{d} of the first cladding is defined as follows. Let r_{d1} be a radius at which the refractive index of the first cladding has the minimum value N_{d1}. Let rₒ₁ be a radius at which the refractive index of the second cladding has the maximum value Nₒ. The outer radius r_{d} is defined as a radius in the range r_{d1}<r_{d}<rₒ₁, where r_{d1} and rₒ₁ are radial positions, such that the derivative dN/dr of the refractive index N(r) with respect to the radius has the maximum value. In other words, r_{d} is defined as a radial position that is located between a radius where the refractive index of the cladding has the minimum value and a radius where the refractive index of the cladding has the maximum value, at which the refractive index increases with increasing radius, and at which the rate of change in the refractive index is the maximum.

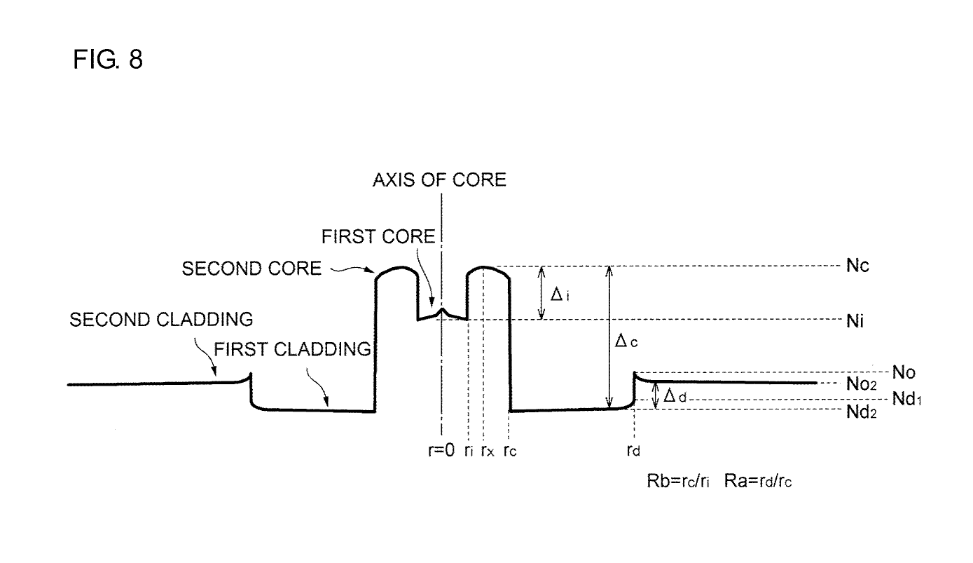

FIG. 8 is a conceptual diagram illustrating a design example of an optical fiber having a ring-core refractive index profile. An optical fiber having a ring-core refractive index profile includes a core that includes a first core and a second core and that has a ring-shaped refractive index profile, a first cladding that surrounds the core, and a second cladding that surrounds the first cladding. Let rᵢ denote the outer radius of the first core and Nᵢ denote the minimum refractive index of the first core. Let r_{c} denote the outer radius of the second core and N_{c} denote the maximum refractive index of the second core. Let r_{d} denote the outer radius of the first cladding, N_{d1} denote the maximum refractive index of the first cladding, and N_{d2} denote the minimum refractive index of the first cladding. Let rₒ denote the outer radius of the second cladding, Nₒ denote the maximum refractive index of the second cladding, and Nₒ₂ denote the minimum refractive index of the second cladding. These parameters satisfy the relationships N_{c}>Nₒ₂>N_{d1} and rᵢ<r_{c}<r_{d}<r^{o}.

Let Δ_{c}=(N_{c}−N_{d2})/N_{d2} denote the relative refractive index difference of the maximum refractive index N_{c} of the second core with respect to the minimum refractive index N_{d2} of the first cladding, and let Δ_{d}=(Nₒ−N_{d2})/N_{d2} denote the relative refractive index difference of the maximum refractive index Nₒ of the second cladding with respect to the minimum refractive index N_{d2} of the first cladding. Let Δᵢ=(Nₒ−Nᵢ)/Nᵢ denote the relative refractive index difference of the maximum refractive index N_{c} of the second core with respect to the minimum refractive index Nᵢ of the first core. Let Ra=r_{d}/r_{c} denote the ratio of the outer radius of the first cladding r_{d} to the outer radius of the second core r_{c}, and let Rb=r_{c}/rᵢ denote the ratio of the outer radius of the second core r_{c} to the outer radius of the first core rᵢ.

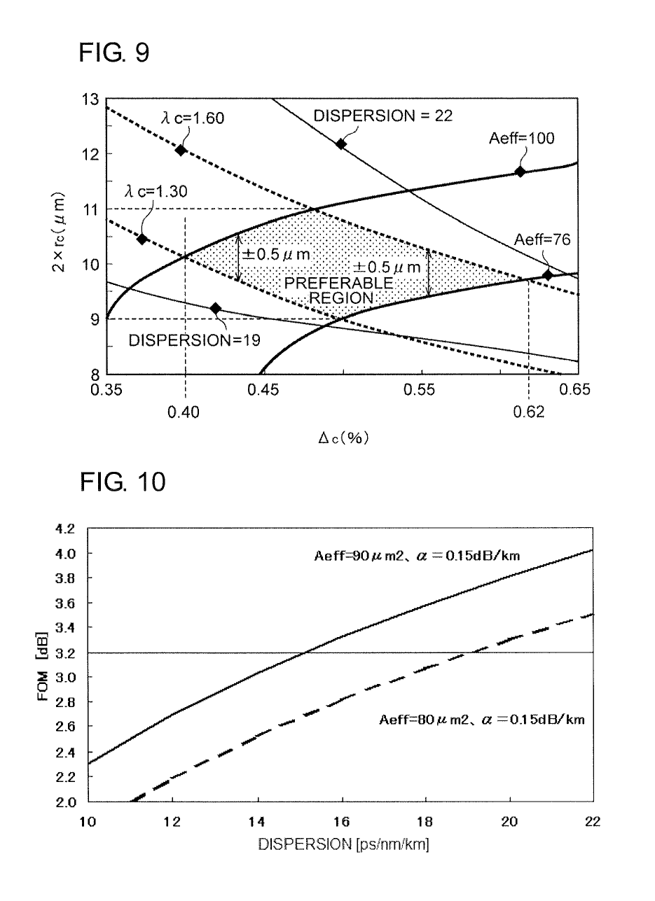

FIG. 9 is a graph representing contour lines of parameters an optical fiber, which has a ring-core refractive index profile, the graph having relative refractive index difference Δ_{c} along the horizontal axis and diameter 2r_{c} along the vertical axis. The curves in FIG. 9 represent the following, where Δ_{d}=0.14%, Δᵢ=0.16%, Ra=4.1, and Rb=2.6: a contour line along which the fiber cut-off wavelength λ_{c} on a 2 m length of optical fiber is 1.60 μm (corresponding to a cable cut-off wavelength of 1.52 μm on a 22 m length of optical fiber); a contour line along which the fiber cut-off wavelength λ_{c} on a 2 m length of optical fiber is 1.30 μm (corresponding to a cable cut-off wavelength of 1.22 μm on a 22 m length of optical fiber); a contour line along which the effective area Aeff at a wavelength of 1550 nm is 100 μm²; a contour line along which the effective area Aeff at a wavelength of 1550 nm is 76 μm²; a contour line along which the chromatic dispersion Disp at a wavelength of 1550 nm is 19 ps/nm/km; and a contour line along which the chromatic dispersion Disp at a wavelength of 1550 nm is 22 ps/nm/km.

It is preferable that the relative refractive index difference Δ_{c} and the diameter 2r_{c} be in a region (hatched region) in which the fiber cut-off wavelength λ_{c}, on a 2 m length of optical fiber is 1.30 μm or more and 1.60 μm or less, the effective area Aeff is 76 μm² or more and 100 μm² or less, and the chromatic dispersion Disp is 19 ps/nm/km or more and 22 ps/nm/km or less. For a ring-core optical fiber, it is preferable that Δ_{c l be} 0.40% or more and 0.62% or less and the core diameter be 9.0 μm or more and 11.0 μm or less. It is more preferable that Δ_{c} be in the range of 0.44 to 0.55% so that a range of the core diameter in which the transmission characteristic is preferable can be broad as ±0.5 μm or more.

It is preferable that the ratio Ra=r_{d}/r_{c} of the outer radius of the first cladding r_{d} to the outer radius of the core r_{c} be 3.0 or more and 4.5 or less. It is preferable that the ratio Rb=r_{c}/rᵢ of the outer radius r_{c} of the second core to the outer radius rᵢ of the first core be in the range of 1.1 to 5. It is preferable that the relative refractive index difference Δ_{d} of the maximum refractive index Nₒ of the second cladding with respect to the minimum refractive index N_{d2} of the first cladding be 0.05% or more and 0.25% or less. The relative refractive index difference Δᵢ of the maximum refractive index N_{c} of the second core with respect to the minimum refractive index Nᵢ of the center core may be 0.05% or more and 0.25% or less. In this case, the bending characteristics can be improved.

The outer radius rᵢ of the first core is defined as follows. Let rᵢ₁ be a radius at which the refractive index of the core has the minimum value Nᵢ. Let rₓ be a radius at which the refractive index of the core has the maximum value N_{c}. The outer radius r_{d} is defined as a radius in the range rᵢ₁<rᵢ<rₓ, where rᵢ₁ and rₓ are radial positions, such that the derivative dN(r)/dr of the refractive index N(r) with respect to the radius has the maximum value. In other words, rⁱ is defined as a radial position that is located between a radius where the refractive index of the core has the minimum value and a radium where the refractive index of the core has the maximum value, at which the refractive index increases with increasing radius, and at which the rate of change in the refractive index is the maximum.

Preferably, the optical fiber has other characteristics described below. It is preferable that the attenuation at the wavelength 1380 nm be as low as 0.8 dB/km or less, more preferably 0.4 dB/km or less, and still more preferably 0.3 dB/km or less. The polarization mode dispersion may be 0.2 ps/√km or less. It is preferable that the cable cut-off wavelength be 1520 nm or less. It is more preferable that the cable cut-off wavelength be 1450 nm or less, which is a pump wavelength used for Raman amplification. The mode field diameter at a wavelength of 1550 nm may be in the range of 8.5 to 11.5 μm. The dispersion slope at a wavelength of 1550 nm may be 0.050 ps/nm²/km or more and 0.070 ps/nm²/km or less. The core and the cladding of an optical-fiber preform may each have a refractive index structure.

It is possible to improve the transmission performance in long-haul and high-capacity transmission by using a transmission system including the optical fiber described above, which has a large effective area Aeff, a large chromatic dispersion Disp, and a large figure of merit FOM. In particular, the attenuation can be reduced and the transmission performance can be improved when the optical fiber is used in optical cables in which optical fibers are packed with a comparative high density, such as terrestrial high-count cables and submarine repeaterless transmission cables.

1. An optical fiber comprising a core and a cladding,
wherein, at a wavelength of 1550 nm, an effective area Aeff is 100 μm² or less and a chromatic dispersion Disp is 19.0 ps/nm/km or more and 22 ps/nm/km or less, and, a figure of merit FOM represented by an expression
FOM=5 log{|Disp|·Leff}−10 log{Leff/Aeff}−100α
is 3.2 dB or more, where an effective length of the optical fiber is denoted by Leff [km] and an attenuation of the optical fiber is denoted by α [dB/km].

2. The optical fiber according to claim 1,
wherein the attenuation α at a wavelength of 1550 nm is 0.164 dB/km or less.

3. The optical fiber according to claim 1,
wherein the effective area Aeff at a wavelength of 1550 nm is 76 μm² or more.

4. The optical fiber according to claim 1,
wherein the effective area Aeff at a wavelength of 1550 nm is 62 μm² or more.

5. The optical fiber according to claim 1,
wherein a fiber cut-off wavelength measured on a 2 m length of the optical fiber is 1.30 or more and 1.60 μm or less.

6. The optical fiber according to claim 1,
wherein a dispersion slope S at a wavelength of 1550 nm is 0.05 ps/nm²/km or more and 0.07 ps/nm²/km or less.

7. The optical fiber according to claim 1,
wherein a splice loss when spliced to a single-mode optical fiber having an effective area of 80 μm² at a wavelength of 1550 nm is 0.05 dB/facet or less.

8. The optical fiber according to claim 1,
wherein a relative refractive index difference of the core with respect to a refractive index of pure silica glass is 0.1% or more and 0.1% or less.

9. The optical fiber according to claim 8,
wherein the core is made of a silica-based glass that is doped with chlorine with an average concentration of 1000 atomic ppm or more.

10. The optical fiber according to claim 8,
wherein the core is doped with an alkali metal with an average concentration of 0.01 atomic ppm or more and 50 atomic ppm or less.

11. The optical fiber according to claim 8,
wherein a concentration of a main-group metal other than alkali metal and a transition metal in the core is 1 ppm or less.

12. The optical fiber according to claim 1,
wherein a diameter 2r_{c} of the core is 9.0 μm or more and 11.6 μm or less, and
wherein a relative refractive index difference Δ_{c}=(N_{c}−N_{d2})/N_{d2} of a maximum refractive index N_{c} of the core with respect to a minimum refractive index N_{d2} of the cladding in a distance range of r_{c} or more and 4.5r_{c} or less from an center axis of the optical fiber is 0.34% or more and 0.62% or less.

13. The optical fiber according to claim 12,
wherein the core includes a first core and a second core, the first core having a minimum refractive index Nᵢ, a maximum refractive index Nᵢ₂, and an outer radius rᵢ, the second core having a maximum refractive index N_{c} and an outer radius r_{c}, where N_{c}≧Nᵢ₂, r_{c}≧rᵢ, and 2r_{c} is 9.0 μm or more and 11.0 μm or less, and
wherein a relative refractive index difference Δ_{c}=(N_{c}−N_{d2})/N_{d2} of the maximum refractive index Nₒ of the second core with respect to the minimum refractive index N_{d2} of the cladding in the distance range of r_{c} or more and 4.5r_{c} or less from the axis is 0.40% or more and 0.62% or less.

14. The optical fiber according to claim 13,
wherein a relative refractive index difference Δᵢ=(N_{c}−Nᵢ)/Nᵢ is 0.05% or more and 0.25% or less.

15. The optical fiber according to claim 12,
wherein the cladding includes a first cladding and a second cladding, the first cladding having an outer radius r_{d}, a maximum refractive index N_{d1}, and a minimum refractive index N_{d2}, the second cladding having an outer radius rₒ, a maximum refractive index Nₒ, and a minimum refractive index N_{O2}, where N_{c}>Nₒ₂>N_{d1} and r_{c}<r_{d}<rₒ,
wherein a relative refractive index difference Δ_{d}=(Nₒ−N_{d2})/N_{d2} of the maximum refractive index Nₒ of the second cladding with respect to the minimum refractive index N_{d2} of the first cladding is 0.05% or more and 0.25% or less, and
wherein a ratio Ra=r_{d}/r_{c} of the outer radius r_{d} of the first cladding to the outer radius r_{c} of the core is 3.0 or more and 4.5 or less.

16. The optical fiber according to claim 1,
wherein the core has a minimum refractive index N, at a distance r, from an center axis of the optical fiber,
wherein the core has a maximum refractive index N_{c} at a distance rₓ from the axis,
wherein, r₁<rₓ≦r_{c}, where an outer diameter of the core is denoted by r_{c}, R_{c}=r_{c}/rₓ is 1 or more and 5.0 or less, and 9 μm≦2r_{c}11 μm,
wherein a relative refractive index difference Δ_{c}=(N_{c}−N_{d2})/Nᵢ of the maximum refractive index N_{c} of the core with respect to the minimum refractive index N, of the core is 0.05% or more and 0.25% or less, and
wherein a relative refractive index difference Δ_{c}=(N_{c}−N_{d2})/Nₒ of the maximum refractive index N_{c} of the core with respect to the minimum refractive index N_{d2} in a distance range of r_{c} or more and 4.5r_{c} or less from the axis is 0.40% or more and 0.62% or less.

17. An optical fiber comprising a core and a cladding,
wherein, at a wavelength of 1550 nm, an effective area Aeff is 62 μm² or more and 100 μm² or less and a chromatic dispersion Disp is 22 ps/nm/km or less, an attenuation α is 0.164 dB/km or less, and a dispersion slope is 0.05 ps/nm²/km or more and 0.07 ps/nm²/km or less.

18. The optical fiber according to claim 18,
wherein the chromatic dispersion is 15 ps/nm/km or more.
